(19) United States
(12) Patent Application Publication
(10) Pub. No.: US 2018/0100214 A1
(43) Pub. Date: Apr. 12, 2018

(54) STEEL FOR HOT FORMING

(71) Applicant: TATA STEEL IJMUIDEN B.V., Velsen-Noord (NL)

(72) Inventors: David Neal HANLON, HILLEGOM (NL); Guido Cornelis HENSEN, HAARLEM (NL); Stefanus Matheus, Cornelis VAN BOHEMEN, HAARLEM (NL)

(73) Assignee: TATA STEEL IJMUIDEN B.V., Velsen-Noord (NL)

(21) Appl. No.: 15/558,255

(22) PCT Filed: Mar. 14, 2016
(86) PCT No.: PCT/EP2016/055449

§ 371 Date: Sep. 14, 2017

(30) Foreign Application Priority Data
Mar. 16, 2015 (EP) EP15020034

(51) Int. Cl. C21D 9/52; C22C 38/38; C22C 38/32; C22C 38/28; C22C 38/06; C22C 38/02; C22C 38/00; C21D 9/46; C21D 9/08; C21D 8/10; C21D 8/02; C21D 1/18; B32B 15/01

(52) U.S. Cl. CPC C21D 9/52; B32B 2311/20; C22C 38/32; C22C 38/28; C22C 38/06; C22C 38/02; C22C 38/002; C22C 38/001; C21D 9/46; C21D 9/08; C21D 8/105; C21D 8/0205; C21D 1/18; B32B 15/012; B32B 15/015; C21D 2211/008; C22C 38/38

(57) ABSTRACT

A steel for hot forming having the following composition in weight %:
C: 0.12-0.24,
Mn: 1.60-2.50,
Si: ≤0.195,
Cr: ≤0.9,
Al: ≤1.3,
P: ≤0.02,
S: ≤0.005,
N: ≤0.03,
B: ≤0.0004,
O: ≤0.008
and optionally:
Ti: ≤0.2,
Mo: ≤0.2,
Nb: ≤0.2,
V: ≤0.2,
Ca: ≤0.05,
the remainder being iron and unavoidable impurities. Also a strip, sheet or blank produced with such a steel, a method for producing a hot formed product, such a product and the use thereof.

The invention relates to a steel for hot forming.

Steels for hot forming are much used, both uncoated and pre-coated, especially in the automotive industry. These steels get high mechanical properties (such as a high strength) after heating to a temperature above the Ac3 temperature, for instance a temperature between 850° C. and 950° C., pressing in a hot forming press and quenching at a velocity above the critical quenching rate. Before heating, these steels have a good formability and a tensile strength between 300 MPa and 500 MPa, for to most grades. After the hot forming process, these steels have a very high tensile strength, which can be above 1500 MPa, and nowadays up to 2000 MPa or even above this strength. However, the elongation of these products is not very good, for instance an elongation of around 5%. The high tensile strength makes the hot formed products especially suitable for use in the body-in-white of automotive vehicles.

Hot forming is generally used for the direct hot forming process, but is also used in the indirect hot forming process. A general picture of hot forming (or hot stamping) is given by A. Naganathan and L. Penter, Chapter 7: Hot Stamping, in Sheet Metal Forming—Processes and Applications, (T. Altan and A. E. Tekkaya, editors), ASM International, 2012.

As indicated in this publication, for automotive purposes usually a boron-alloyed steel is used, in particular steel grade 22MnB5. The chemical composition can differ between steel suppliers, but usually the amount of carbon is approximately 0.22 weight % (usually between 0.20 and 0.25 weight %), the amount of manganese is approximately 1.27 weight % (usually between 1.00 and 1.40 weight %), the amount of silicon is approximately 0.25 weight % (usually between 0.10 and 0.40 weight %), the amount of chromium is approximately 0.15 weight % (usually between 0.1 and 0.50 weight %) and the amount of boron is approximately 0.0030 weight % (usually between 0.0020 and 0.0040 weight %). Other elements should be low, such as sulphur and phosphorus for general metallurgical reasons, and other elements can be present in small amounts, such as nickel, copper, aluminium, vanadium and titanium.

Steel grade 22MnB5 is often pre-coated before it is used in the hot forming process. The pre-coating that is generally used is a AlSi coating.

It is an object of the invention to optimize the mechanical properties of the hot formed product.

It is a further object of the invention to provide a steel for hot forming that provides an alternative to the known steels for hot forming, such as 22MnB5.

It is another object of the invention to provide a steel for hot forming that can be used by the automotive industry without changes to the equipment used at present.

It is a further object of the invention to provide a steel for hot forming which enables a more efficient use of the hot forming equipment.

According to the invention a steel for hot forming is provided having the following composition in weight %:
C: 0.12-0.24,
Mn: 1.60-2.50,
Si: ≤0.195,
Cr: ≤0.9,
Al: ≤1.3,
P: ≤0.02,
S: ≤0.005,
N: ≤0.03,
B: ≤0.0004,
O: ≤0.008
and optionally:
Ti: ≤0.2,
Mo: ≤0.2,
Nb: ≤0.2,
V: ≤0.2,
Ca: ≤0.05,
the remainder being iron and unavoidable impurities.

The inventors have found that the mechanical properties of the hot formed product are optimized because the number of non-metallic constituents in the steel substrate are reduced. Non-metallic constituents reduce the homogeneity of the substrate and these inhomogeneities can lead to local stress concentrations and pre-mature failure of a mechanically loaded product. Typical non-metallic constituents in steel are TiN, BN, Fe₂₆(B,C)₆, MnS, AlN, CaS, Al₂O₃, P, Fe₃C etc. The invented steel composition is aimed to reduce the size and amount of all these non-metallic constituents by reducing the amount of B, Ti, S, Ca, Al, P and other required chemical elements.

The nowadays commonly used 22MnB5 substrate composition contains 20 to 40 ppm boron (B) to improve the hardenability during hot forming operations. To maintain this element in its functional state, the steelmaker adds titanium (Ti) to the cast to prevent B to form boron nitride (BN). The presence of BN near the surface can deteriorate the quality of the hot dipped coating which is usually present. The Ti is normally added in an over-stochiometric ratio to the nitrogen (N) to maximize the efficiency of the added amount of B. Boron is also known to form fine Fe₂₆(B,C)₆ complex precipitates that can lead to local stress concentrations in the matrix. Therefore the inventors have reduced the B from the steel composition to limit the presence of B based non-metallic constituents. For this reason, B is present in an amount lower then 0.0004 weight % or 4 ppm. To compensate for the loss of hardenability by reducing the amount of B, the inventors added manganese (Mn) and/or chromium (Cr).

Mn is a favourable metallic component because of its compatibility with the iron matrix. Moreover, the addition of more Mn than in the commonly used 22MnB5 reduces the Ac₁ and Ac₃ temperature of the steel substrate (temperature at which the substrate starts to transform to austenite and when it is fully austenitic respectively). This means that a lower furnace temperature can be utilized to austenitize the substrate prior to hot forming. Reducing the furnace temperature is economically and environmentally favourable and also opens up new process opportunities for Zn, Zn alloy or Al and Al alloy coatings. For Zn alloy coatings it is commonly known that an increased furnace temperature reduces the corrosion performance of the hot formed product. For Al or Al alloy coatings it is known that high furnace temperatures reduce the weldability of the component. A steel composition that enables the use of lower furnace temperatures is therefore favourable over the commonly used 22MnB5. For this reason, Mn is present in an amount of 1.60 to 2.5 weight %.

In contrast to B, Mn does strengthen the substrate by solid solution strengthening. Furthermore, Mn additions also lower the Mₛ temperature (temperature at which Martensite forms upon cooling), which means that less (auto-)tempering will occur and therefore the substrate will have a higher martensite strength at room temperature. Due to both strengthening mechanisms, the inventors claim that they can reduce the amount of carbon (C) in steel substrates for hot forming and obtain a similar strength level as achieved with 22MnB5. Reducing the amount of C is favourable to prevent Fe3C formation during (auto-)tempering during the hot forming process step. Fe3C precipitates can introduce local inhomogeneities and stress concentrations during mechanically loading, leading to premature failure of the product. Furthermore, the spot-weldability of hot-formed products will improve due to the lower C content in the inventive steel substrate. Therefore, C is present in an amount of 0.12 to 0.24 weight %.

Similar to Mn, Cr increases the hardenability, and it also lowers the Mₛ temperature. Furthermore, Cr contributes to the strength of the substrate by solid solution strengthening. Cr is present in an amount less then 0.9 weight %.

Si also delivers a solid solution strengthening contribution. In addition, Si retards the (auto)tempering because of its weak solubility in carbides. Si is present in an amount of at most 0.195 weight %. Higher amounts negatively affect the surface quality and roll ability.

Sulphur (S) is a common element found in steel substrates. Steelmakers use various desulphurization methods to reduce the amount of S because it could lead to hot-shortness during continuous casting. S can also precipitate with manganese (Mn) to form soft MnS inclusions. During hot rolling and subsequent cold rolling, these inclusions are elongated and form relatively large inhomogeneities that could lead to premature failure, especially when loaded in the tangential direction. Calcium (Ca) can be added to spherodize the S containing inclusions and to minimize the amount of elongated inclusions. However, the presence of CaS inclusions will still lead to inhomogeneities in the matrix. Therefore, it is best to reduce S. S should not be present in an amount higher then 0.005 weight %. Ca should be present in an amount less then 0.05 weight %.

Aluminium (Al) is normally added to steel in an over-stoichiometric ratio to oxygen (O) to prevent carbon monoxide (CO) formation during continuous casting by reducing the available amount of free O through formation of aluminium oxide Al₂O₃. The formed Al₂O₃ normally forms a slag on top of the liquid steel, but can be entrapped in the solidifying steel during casting. During subsequent hot and cold-rolling, this inclusion will become segmented and forms non-metallic inclusions that lead to premature fracture upon mechanically loading the product. The over-stoichometric Al precipitates as aluminium nitrides (AlN) which also leads to local inhomogeneities in the steel matrix. Thus, Al should be present in an amount of less then 1.3 weight %.

Nitrogen (N) and Oxygen (O) should also be present in low amount because these elements form inclusions with other elements. Less then 0.02 weight % P and less then 0.008 weight % O should be present in the steel.

Some elements can be optionally present in the steel. Since there is no need to form TiN nitrides because B needs not to be a free element anymore, Ti can be present in an amount lower then 0.2 weight %, and it is possible not to add Ti at all. The same holds for Mo, Nb, and V.

For the abovementioned elements, the lower limit for Si, Cr and Al is 0.001 wt %, and usually the lower limit for Si and Cr is 0.01 wt % and for Al is 0.005 wt % in practice. For S, N and P the lower limit is 1 ppm (0.0001 wt %), and in practice the lower limit is usually 0.001 wt %.

Preferably the more limited amounts of the elements according to claim 2 or 3 are used. It will be clear that a more limited amount of the elements as specified in claims 2 and 3 provides a steel in which the number of non-metallic constituents in the steel substrate are further reduced. For instance, the over-stochiometric amount of Ti will form titanium nitrides, which are known as hard, non-deformable inclusions. By limiting the amount of Ti and N, the TiN inclusions are limited.

The claims shows that it is possible to use a steel for hot forming in which no to boron is added, such that the boron in the steel will be only present as an unavoidable impurity. Though the amount of boron that will be present as an impurity will depend on the raw materials used in the ironmaking process and also depends on the steelmaking process, the inventors have found that the impurity level for boron that is nowadays obtained has usually a maximum of 0.0001 weight % or 1 ppm.

Preferably the amount of Mn and Cr is such that Mn+Cr≥2.5 weight %, preferably Mn+Cr≥2.6 weight %. For these amounts, the mechanical properties of the steel are always sufficient.

The steel for hot forming as described above is used for producing a strip, sheet, blank or tube having the usual dimensions, such as a hot-rolled and optionally cold rolled strip having a length of more than 100 m, a width between 800 and 1700 mm, and a thickness between 0.8 and 4.0 mm. Such a strip is cut into sheets and blanks or formed into a tube.

Preferably, the strip, sheet, blank or tube is pre-coated with a layer of aluminium or an aluminium based alloy, or pre-coated with a layer of zinc or a zinc based alloy. Pre-coated blanks and tubes are preferred by the automotive industry for body-in-white parts.

Preferably the pre-coating comprises 5 to 13 wt % silicon and/or less than 5 wt % iron, the remainder being aluminium, the pre-coating preferably having a thickness between 10 and 40 μm per side, more preferably a thickness between 20 and 35 μm per side. Such thicknesses provide a good corrosion protection for the hot formed parts coated with the specified aluminium alloy.

More preferably, the pre-coating comprised 8 to 12 wt % silicon and/or 2 to 5 wt % iron, the remainder being aluminium. Such an aluminium-alloy pre-coating is commonly used.

According to another preferred embodiment the pre-coating is an iron-zinc diffusion coating obtained by heat treating a zinc layer, the zinc layer comprising Al<0.18 wt % and Fe<15 wt %, the remainder being zinc and traces of other elements, the pre-coating preferably having a thickness between 5 and 15 μm per side, more preferably a thickness between 6 and 13 μm per side. This zinc pre-coating provides good corrosion properties.

According to a further preferred embodiment the pre-coating comprises 0.5 to 4 wt % Al and 0.5 to 3.2 wt % Mg, the remainder being zinc and traces of other elements, the coating layer preferably having a thickness between 5 and 15 μm per side, more preferably a thickness between 6 and 13 μm per side. This pre-coating provides even better corrosion properties.

According to the invention furthermore is provided a method for producing a hot formed product using the strip, sheet, blank or tube as described above, using the following steps:
providing a blank, for instance by cutting the strip or sheet, or tube
heating the blank or tube to a temperature above the Ad temperature of the steel, preferably above the Ac3 temperature of the steel, to a temperature of at most 1000° C.
transporting the heated blank or tube into a hot forming press
forming the blank or tube into a product in the press
quenching the product with an average cooling rate between the furnace and Mₛ temperature above the critical quenching rate (CQR).

The CQR is defined as the cooling rate to obtain the required mechanical properties (Rₘ>1300 MPa) and is lower than the critical cooling rate (CCR) which is the minimal cooling rate at which 100% martensite is formed.

Using this method a hot formed product is produced having the mechanical properties as needed for automotive purposes, which product is either uncoated or coated, dependent on the blank used. As elucidated above, the Ac1 and Ac3 temperatures are lower for the composition according to the invention as compared to the commonly used 22MnB5 type steel.

Preferably the blank or tube is at least partially heated to a temperature higher than the Ac1 temperature, preferably higher than the Ac3 temperature, but lower than 950° C., preferably lower than 900° C. Since the Ac1 and Ac3 temperatures are lower for the composition according to the invention, as discussed above, it is preferably even possible to use heating temperatures below 900° C.

According to a preferred embodiment the heated blank is forcibly cooled before putting it in the hot forming press. Such cooling positively influences the properties of the formed product.

The invention also encompasses a product produced using the method as described above. This product has the mechanical properties provided by the hot forming method, as needed for automotive or other purposes.

Preferably a product as described above is used in a motor vehicle. For this purpose also other properties besides mechanical properties are have to be taken into account, such as the weldability of the product.

The invention will be elucidated with reference to the examples below.

The inventors have casted multiple compositions into 25 kg ingots. These ingots were subsequently hot rolled with a finish temperature of 900° C., a coiling temperature of 630° C. and a hot rolled gauge of 4 mm. Subsequently the strips were pickled and cold rolled to 1.5 mm gauge. Using dilatometry the composition dependent Ac₃ temperature, Mₛ temperature and Critical Cooling Rate (CCR) of the compositions have been determined. For these tests, samples were heated in a Bahr 805A Dilatometer to a temperature of 900° C. with a mean heating rate of 15° C./s from room temperature up to 650° C. and with a mean heating rate of 3° C./s from 650-900° C. After 3 minutes of soaking at 900° C. the samples were quenched. The obtained data is given in Table 1 for various chemical compositions.

TABLE 1

| Short | Composition | C | Mn | Si | Cr | Al | S | P | N | Ti | B | O | Mₛ | Ac₃ | CCR |
|---|---|---|---|---|---|---|---|---|---|---|---|---|---|---|---|
| ID | ID | [wt %] | [wt %] | [wt %] | [wt %] | [wt %] | [wt %] | [wt %] | ppm | [wt %] | ppm | wt % | [° C.] | [° C.] | [° C./s |
| 77A | 0.07Si | 0.190 | 2.05 | 0.07 | 0.60 | 0.02 | 0.003 | 0.009 | 60 | <0.005 | <3 | <0.005 | 380 | 810 | 35 |
| 77B | 0.19Si | 0.195 | 2.04 | 0.19 | 0.60 | 0.02 | 0.002 | 0.008 | 60 | <0.005 | <3 | <0.005 | 380 | 815 | 35 |
| 80 | 0.06Si | 0.200 | 2.19 | 0.06 | 0.65 | 0.036 | 0.001 | 0.010 | 42 | <0.005 | <3 | <0.005 | | | |
| 1A | 22MnB5 | 0.230 | 1.17 | 0.238 | 0.200 | 0.011 | 0.004 | 0.009 | 29 | 0.021 | 26 | <0.005 | 400 | 830 | 30 |

With the usual measuring equipment the amount of Ti and B could not be measured more accurately than indicated in Table 1. The table shows that the amount of Ti is low enough. The amount of O has not been measured but it is known that for such steel types the amount is less then 50 ppm in laboratory samples. Steel produced during commercial full-scale production of these steel types has shown to contain less then 30 ppm O.

Other test samples produced under laboratory condition show to contain 1 to 3 ppm B when no boron has been added to the steel. This variation in the amount of boron can be explained by a small contamination of the steelmaking equipment with previously produced boron containing steels. Commercial full-scale production of such types of steel to which no boron has been added contain an amount of less than 2 ppm boron; usually an amount of less then 1 ppm boron is measured.

To demonstrate the effect of the beneficial influence of the absence of non-metallic constituents on the mechanical properties, the inventors performed hot forming trials. 1.5 mm gauge steel blanks were heated to 900° C. with a total furnace time of 5 minutes. The blanks were taken out of the furnace, transported to the press within 10 seconds and pressed in between flat tools at a temperature of approximately to 780° C. The flat pressing tools had a temperature between 20 and 80° C. and the press was closed for approximately 20 seconds. The cooling rate of the blanks in the press was between 50 and 100° C./s directly after the press was closed. The average cooling rate of the blank after leaving the furnace until reaching the martensite start temperature was higher than the critical quenching rate of the substrates as can be seen from the resulting mechanical properties in Table 2. These results also demonstrate that even though the carbon levels of the invented substrates are lower, the yield strength (Rₚ) and tensile strength (Rₘ) are similar to the commonly used 22MnB5. However, due to the reduced number of non-metallic constituents, the invented substrates 77A and 77B have higher total elongation compared to the commonly used 22MnB5.

TABLE 2

| | | Furnace | Transport | | | | |
|---|---|---|---|---|---|---|---|
| Cast: | | Temperature | time | Rp | Rm | Ag | A |
| [No.] | Composition ID | [° C.] | [s] | [MPa] | [MPa] | [%] | [%] |
| 77A | 0.07Si | 900 | 8 | 1168 | 1566 | 3.5 | 6.2 |
| 77B | 0.19Si | 900 | 8 | 1181 | 1573 | 3.8 | 6.7 |
| 80 | 0.06Si | 900 | 8 | 1096 | 1508 | 3.5 | 6.0 |
| 1A | 22MnB5-Lab | 900 | 8 | 1137 | 1555 | 3.7 | 6.0 |

1. A steel for hot forming having the following composition in weight %:
C: 0.12-0.24,
Mn: 1.60-2.50,
0.001≤Si: ≤0.195,
0.15≤Cr: ≤0.9,
0.001≤Al: ≤1.3,
0.0001≤P: ≤0.02,
0.0001≤S: ≤0.005,
0.0001≤N: ≤0.03,
B: ≤0.0004,
O: ≤0.008
and optionally:
Ti: ≤0.2,
Mo: ≤0.2,
Nb: ≤0.2,
V: ≤0.2,
Ca: ≤0.05,
the remainder being iron and unavoidable impurities.

2. The steel according to claim 1, wherein the steel comprises in weight %:
C: 0.15-0.23 and/or
Mn: 1.70-2.40 and/or
Si: ≤0.19 and/or
Cr: 0.15-0.80 and/or
Al: ≤1.0 and/or
P: ≤0.02 and/or
S: ≤0.005 and/or
N: ≤0.01 and/or
B: ≤0.0004 and/or
O: ≤0.008 and/or
and optionally:
Ti: ≤0.1 and/or
Mo: ≤0.1 and/or
Nb: ≤0.1 and/or
V: ≤0.1 and/or
Ca: ≤0.01
the remainder being iron and unavoidable impurities.

3. The steel according to claim 1, wherein the steel comprises in weight %:
C: 0.17-0.22 and/or
Mn: 2.00-2.30 and/or
Si: 0.02-0.10 and/or
Cr: 0.30-0.70 and/or
Al: <0.10 and/or
P: <0.015 and/or
S: <0.003 and/or
N: <0.006 and/or
B: <0.0003 and/or
O: ≤0.008 and/or
and optionally:
Ti: <0.05 and/or
Mo: <0.05 and/or
Nb: <0.05 and/or
V: <0.05 and/or
Ca: 0.01-0.05
the remainder being iron and unavoidable impurities.

4. The steel according to claim 1, wherein the steel comprises in weight %:
C: 0.19-0.22 and/or
Mn: 2.00-2.25 and/or
Si: 0.03-0.08 and/or
Cr: 0.60-0.70 and/or
Al: 0.015-0.055 and/or
P: <0.015 and/or
S: <0.003 and/or
N: <0.006 and/or
B: <0.0003 and/or
O: ≤0.008 and/or
and optionally:
Ti: <0.01 and/or
Mo: <0.015 and/or
Nb: <0.005 and/or
V: <0.01 and/or
Ca: 0.013-0.050
the remainder being iron and unavoidable impurities.

5. The strip, sheet, blank, or tube produced with the steel according to claim 1.

6. The strip, sheet, blank or tube according to claim 5, pre-coated with a layer of aluminium or an aluminium based alloy, or pre-coated with a layer of zinc or a zinc based alloy.

7. The strip, sheet, blank or tube according to claim 6, wherein the pre-coating comprised 5 to 13 wt % silicon and/or less than 5 wt % iron, the remainder being aluminium, the pre-coating having a thickness between 10 and 40 μm per side.

8. The strip, sheet, blank or tube according to claim 7, wherein the pre-coating comprised 8 to 12 wt % silicon and/or 2 to 5 wt % iron, the remainder being aluminium.

9. The strip, sheet, blank or tube according to claim 6, wherein the pre-coating is an iron-zinc diffusion coating obtained by heat treating a zinc layer, the zinc layer comprising Al<0.18 wt % and Fe<15 wt %, the remainder being zinc and traces of other elements, the pre-coating preferably having a thickness between 5 and 15 μm per side.

10. The strip, sheet, blank or tube according to claim 6, wherein the pre-coating comprises 0.5 to 4 wt % Al and 0.5 to 3.2 wt % Mg, the remainder being zinc and traces of other elements, the pre-coating having a thickness between 5 and 15 μm per side.

11. The method for producing a hot formed product using the strip, sheet, blank or tube according to claim 6, using the following steps:
providing a blank, for instance by cutting the strip or sheet, or tube
heating the blank or tube to a temperature above the Ac1 temperature of the steel, to a temperature of at most 1000° C.
transporting the heated blank or tube into a hot forming press
forming the blank or tube into a product in the press
quenching the product with an average cooling rate between the furnace temperature and the M_{S} temperature above the critical quenching rate CQR which is defined as the cooling rate to obtain an Rm>1300 MPa.

12. The method according to claim 11, wherein the blank or tube is at least partially heated to a temperature higher than Ac₁, but lower than 950° C.

13. The method according to claim 11, wherein the heated blank or tube is forcibly cooled before putting it in the hot forming press.

14. A product produced using the method according to claim 11.

15. The product according to claim 14, wherein the part is a motor vehicle part.

16. The strip, sheet, blank or tube according to claim 7, wherein the pre-coating thickness is between 20 and 35 μm per side.

17. The method according to claim 11, wherein said heating of the blank or tube is to a temperature above the Ac3 temperature of the steel, to a temperature of at most 1000° C.

18. The method according to claim 12, wherein the temperature to which the blank or tube is at least partially heated is higher than Ac₃, but lower than 900° C.

19. The steel according to claim 1, wherein the steel comprises in weight %:
C: 0.15-0.23
Mn: 1.70-2.40
Si: ≤0.19
Cr: 0.15-0.80
Al: ≤1.0
P: <0.02
S: ≤0.005
N: ≤0.01
B: ≤0.0004
O: ≤0.008
and optionally:
Ti: ≤0.1
Mo: ≤0.1
Nb: ≤0.1
V: <0.1
Ca: ≤0.01
the remainder being iron and unavoidable impurities.

20. The steel according to claim 1, wherein the steel comprises in weight %:
C: 0.17-0.22
Mn: 2.00-2.30
Si: 0.02-0.10
Cr: 0.30-0.70
Al: <0.10
P: <0.015
S: <0.003
N: <0.006
B: <0.0003
O: ≤0.008
and optionally:
Ti: <0.05
Mo: <0.05
Nb: <0.05
V: <0.05
Ca: 0.01-0.05
the remainder being iron and unavoidable impurities.

21. The steel according to claim 1, wherein the steel comprises in weight %:
C: 0.19-0.22
Mn: 2.00-2.25
Si: 0.03-0.08
Cr: 0.60-0.70
Al: 0.015-0.055
P: <0.015
S: <0.003
N: <0.006
B: <0.0003
O: ≤0.008
and optionally:
Ti: <0.01
Mo: <0.015
Nb: <0.005
V: <0.01
Ca: 0.013-0.050
the remainder being iron and unavoidable impurities.
